(19) United States
(12) Patent Application Publication
(10) Pub. No.: US 2008/0050143 A1
(43) Pub. Date: Feb. 28, 2008

(54) Shared High Voltage Power Supply for Photoconductor Charging in an Electrophotographic Device

(76) Inventor: Raymond Jay Barry, Lexington, KY (US)

Correspondence Address: John J. McArdle, Jr.;Lexmark International, Inc., Intellectual Property Department, 740 West New Circle Road, Lexington, KY, 40550, US

(21) Appl. No.: 11/466,470

(22) Filed: Aug. 23, 2006

(51) Int. Cl. G03G 15/00; G03G 15/02

(52) U.S. Cl. 399/89

(57) ABSTRACT

A photoconductor charging system for use with an image forming device. The image forming device may include a plurality of image forming units transferring toner particles to a media substrate and each of the plurality of image forming units including a photoconductive unit and a corresponding charging unit positioned to charge the photoconductive unit. Generally, an alternating current power supply may be coupled to one or more of the charging units and supply a voltage thereto. The alternating current power supply may include a switching mode amplifier. In one embodiment, the switching mode amplifier is a class D amplifier. The charging system may further include a filter to filter an output of the switching mode amplifier. The filter may include a low pass L-C filter. The switching mode amplifier may operate a transistor output bridge between on and off states to improve amplifier efficiency.

### BACKGROUND

The invention relates generally to an image forming device, and more particularly, to an image forming device having an efficient, shared, high-voltage power supply.

The electrophotography process used in some imaging devices, such as laser printers and copiers, utilizes electrical potentials between components to control the transfer and placement of toner. These electrical potentials create attractive and repulsive forces that tend to promote the transfer of charged toner to desired areas while ideally preventing transfer of the toner to unwanted areas. For instance, during the process of developing a latent image on a photoconductive surface, charged toner particles may be deposited onto latent image features (e.g., corresponding to text or graphics) on the photoconductive surface having a lower surface potential than the charged particles.

The precise magnitudes of these electrical potentials and the nature of the voltages (e.g., AC or DC) varies among devices and manufacturers. In general, however, a laser or imaging source is used to illuminate and selectively discharge portions of a photoconductive surface to create a latent image having a lower surface potential than the remaining, undischarged areas of the photoconductive surface. The toner is charged to some intermediate level between the discharge potential of the latent image and the surface potential of the undischarged photoconductive surface. Thus, the toner is attracted to the latent image yet repelled by the undischarged areas.

An image-forming device, such as a color printer, typically includes four image forming units associated with four colors: cyan, magenta, yellow, and black. Each image forming unit includes an optical source that is scanned to produce a latent image on the charged surface of a photoconductive unit. Conventionally, the photoconductive surface is charged using a dedicated power supply. That is, each photoconductive unit may have an associated power supply including a dedicated power amplifier. Other systems may share a power supply among colors that are not commonly used simultaneously or among photoconductors that are spaced apart. In either case, multiple power supplies are still required, largely due to inefficiency of conventional supplies. Unfortunately, each power supply is costly and occupies a relatively large spatial volume. The image-forming device, like all consumer products, should be constructed in an economical manner. Price is one of the leading factors when a user makes a purchasing decision. Further, quality and size of the resulting product are other guiding factors in the design and manufacture of image forming devices.

### SUMMARY

Embodiments disclosed herein are directed to a photoconductor charging system for use with an image forming device. The image forming device may include a plurality of image forming units transferring toner particles to a media substrate. Each of the plurality of image forming units may include a photoconductive unit and a corresponding charging unit positioned to charge the photoconductive unit. Generally, an alternating current (AC) power supply may be coupled to one or more of the charging units and supply a voltage thereto. Further, a direct current (DC) power supply may be coupled to one or more of the charging units and supply a voltage thereto. In one embodiment, the AC power supply may be shared among multiple charging units while separate DC power supplies may be used for each charging unit. Other combinations are certainly possible. The alternating current power supply may include a switching mode amplifier. In one embodiment, the switching mode amplifier is a class D amplifier. The charging system may further include a filter to filter an output of the switching mode amplifier. The filter may include a low pass L-C filter. The switching mode amplifier may operate a transistor output bridge between on and off states to improve amplifier efficiency.

In operation the switching mode amplifier may convert an oscillating input signal to a pulse-width-modulated (PWM) signal by comparing the oscillating input signal to a predetermined reference signal. The PWM signal may be used to drive a transistor output bridge so that the transistors switch between ON and OFF states to respectively produce a substantially binary output voltage. The binary output voltage may be filtered to produce an alternating current signal that is then transformed to a high voltage alternating current signal. Then the high voltage alternating current signal may be applied to a photoconductor charging unit to charge a photoconductive surface of a photoconductor.

### BRIEF DESCRIPTION OF THE DRAWINGS

FIG. 1 is a functional block diagram of an image forming device according to one embodiment;

FIG. 2 is a schematic diagram of an image forming unit according to one embodiment;

FIG. 3 is a functional block diagram of a charging system to charge photoconductors in an image forming device according to one embodiment;

FIG. 4 is an electrical schematic diagram of a charging system to charge photoconductors in an image forming device according to one embodiment;

FIG. 5 is an electrical schematic diagram of a switching mode amplifier used in a charging system to charge photoconductors in an image forming device according to one embodiment;

FIG. 6 is an electrical schematic diagram of a charging system to charge photoconductors in an image forming device according to one embodiment;

FIG. 7 is a functional block diagram of a charging system to charge photoconductors in an image forming device according to one embodiment; and

FIG. 8 is a functional block diagram of a charging system to charge photoconductors in an image forming device according to one embodiment.

### DETAILED DESCRIPTION

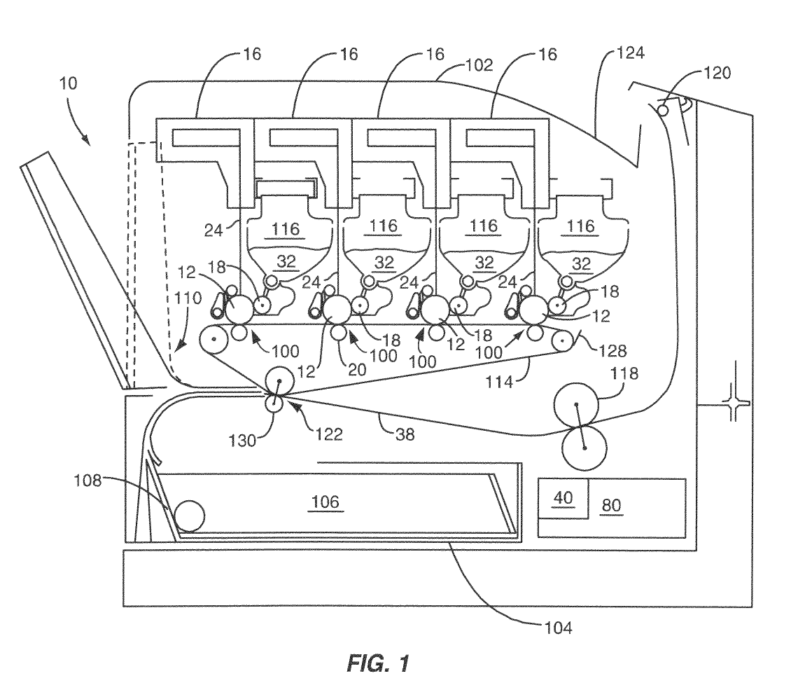

in electrophotographic image development, the use of alternating current (AC) power supplies in charging photoconductive surfaces provides advantages in print quality and stability of print quality over the life of the power supply. However, a major drawback of conventional supplies derives from their relatively large size and inefficient operation. An improved, shared, high-efficiency, AC power supply may be implemented in a device such as the image forming device 10 generally illustrated in FIG. 1 and may be implemented with various embodiments disclosed herein. The image-forming device 10 comprises a housing 102 and a media tray 104. The media tray 104 includes a main stack of media sheets 106 and a sheet pick mechanism 108. The image-forming device 10 also includes a multipurpose tray 110 for feeding envelopes, transparencies and the like. The media tray 104 may be removable for refilling, and located in a lower section of the device 10.

Within the image-forming device housing 102, the image-forming device 10 includes one or more removable developer cartridges 116, photoconductive units 12, developer rollers 18 and corresponding transfer rollers 20. The image forming device 10 also includes an intermediate transfer mechanism (ITM) belt 114, a fuser 118, and exit rollers 120, as well as various additional rollers, actuators, sensors, optics, and electronics (not shown) as are conventionally known in the image forming device arts, and which are not further explicated herein. Additionally, the image-forming device 10 includes one or more system boards 80 comprising controllers, microprocessors, DSPs, or other stored-program processors (not specifically shown in FIG. 1) and associated computer memory, data transfer circuits and/or other peripherals (not shown) that provide overall control of the image formation process. The system board 80 may further include power supply 40 described in greater detail below. In one embodiment, the power supply 40 is implemented separate from a system board 80.

Each developer cartridge 116 may include a reservoir containing toner 32 and a developer roller 18, in addition to various rollers, paddles and other elements (not shown). Each developer roller 18 is adjacent to a corresponding photoconductive unit 12, with the developer roller 18 developing a latent image on the surface of the photoconductive unit 12 by supplying toner 32. In various alternative embodiments, the photoconductive unit 12 may be integrated into the developer cartridge 116, may be fixed in the image forming device housing 102, or may be disposed in a removable photoconductor cartridge (not shown). In a typical color image forming device, three or four colors of toner—cyan, yellow, magenta, and optionally black—are applied successively (and not necessarily in that order) to an ITM belt 114 or to a print media sheet 106 to create a color image. Correspondingly, FIG. 1 depicts four image forming units 100. In a monochrome printer, only one forming unit 100 may be present.

The operation of the image-forming device 10 is conventionally known. Upon command from control electronics, a single media sheet 106 is “picked,” or selected, from either the primary media tray 104 or the multipurpose tray 110 while the ITM belt 114 moves successively past the image forming units 100. As described above, at each photoconductive unit 12, a latent image is formed thereon by optical projection from the imaging device 16. The latent image is developed by applying toner to the photoconductive unit 12 from the corresponding developer roller 18. The toner is subsequently deposited on the ITM belt 114 as it is conveyed past the photoconductive unit 12 by operation of a transfer voltage applied by the transfer roller 20. Each color is layered onto the ITM belt 114 to form a composite image, as the ITM belt 114 passes by each successive image-forming unit 100. The media sheet 106 is fed to a secondary transfer nip 122 where the image is transferred from the ITM belt 114 to the media sheet 106 with the aid of transfer roller 130. The media sheet proceeds from the secondary transfer nip 122 along media path 38. The toner is thermally fused to the media sheet 106 by the fuser 118, and the sheet 106 then passes through exit rollers 120, to land facedown in the output stack 124 formed on the exterior of the image forming device housing 102. A cleaner unit 128 cleans residual toner from the surface of the ITM belt 114 prior to the next application of a toner image.

The representative image-forming device 10 shown in FIG. 1 is referred to as a dual-transfer device because the developed images are transferred twice: first to the ITM belt 114 at the image forming units 100 and second to a media sheet 106 at the transfer nip 122. Other image forming devices implement a sing e-transfer mechanism where a media sheet 106 is transported by a transport belt (not shown) past each image-forming unit 100 for direct transfer of toner images onto the media sheet 106. The power supplies 40 disclosed herein may be used for either type of image forming device.

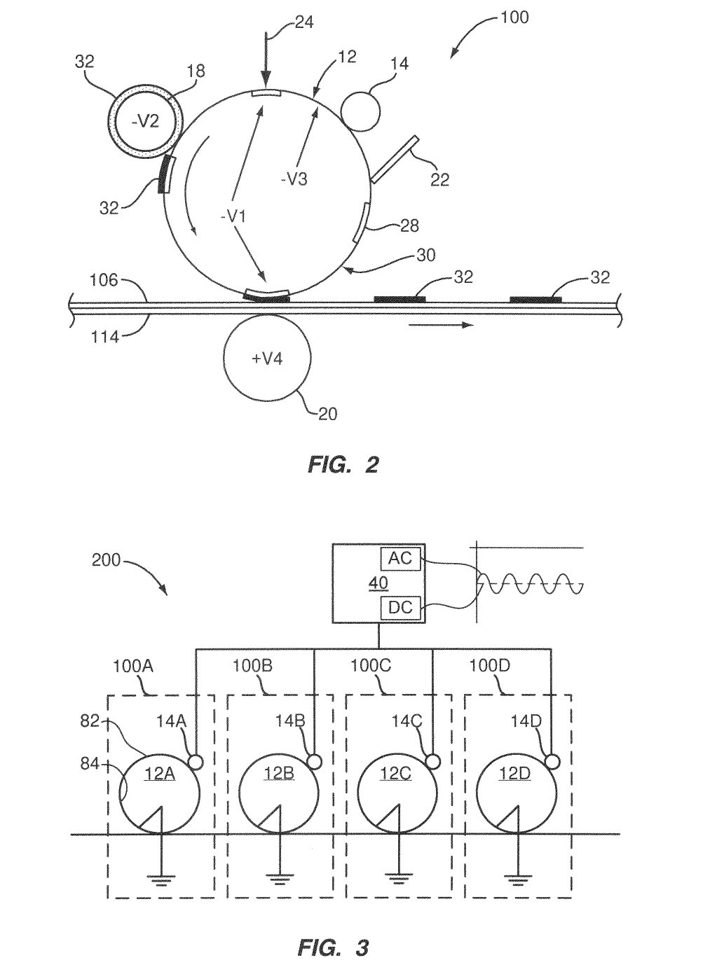

FIG. 2 is a schematic diagram illustrating an exemplary image-forming unit 100. Each image-forming unit 100 includes a photoconductive unit 12, a charging unit 14, an imaging device 16, a developer roller 18, a transfer device 20, and a cleaning blade 22. In the embodiment depicted, the photoconductive unit 12 is cylindrically shaped and illustrated in cross section. However, it will be apparent to those skilled in the art that the photoconductive unit 12 may comprise any appropriate shape or structure, including but not limited to belts or plates. The charging unit 14 charges the surface of the photoconductive unit 12 to a potential identified as −V3. As indicated above, an AC voltage may be used to charge the surface of the photoconductive unit 12. A laser beam 24 from a source, such as a laser diode, in the imaging device 16 selectively discharges discrete areas 28 on the photoconductive unit 12 to form a latent image on the surface of the photoconductive unit 12. The energy of the laser beam 24 selectively discharges these discrete areas 28 of the surface of the photoconductive unit 12 to a lower potential identified as −V1 in the embodiment depicted. Areas of the latent image not to be developed by toner (also referred to as “white” or “background” image areas) are indicated generally by the numeral 30 and retain the potential −V3 induced by the charging unit 14.

The latent image thus formed on the photoconductive unit 12 is then developed with toner from the developer roller 18, on which is adhered a thin layer of toner 32. The developer roller 18 is biased to a potential −V2 that is intermediate to the surface potential −V1 of the discharged latent image areas 28 and the surface potential −V3 of the undischarged areas not to be developed 30. As is well known in the art, the photoconductive unit 12, developer roller 18 and toner 32 may be charged alternatively to positive voltages.

In this manner, the latent image on the photoconductive unit 12 is developed by toner 32, which is subsequently transferred to a media sheet 106 by the positive voltage +V4 of the transfer device 20. Alternatively, the toner 32 developing an image on the photoconductive unit 12 may be transferred to an ITM belt 114 and subsequently transferred to a media sheet 106 at a second transfer location (not shown in FIG. 2, but see location 122 in FIG. 1). After the developed image is transferred off the photoconductive unit 12, the cleaning blade 22 removes any remaining toner from the photoconductive unit 12, and the photoconductive unit 12 is again charged to a uniform level by the charging device 14.

FIG. 3 depicts a simplified representation of the charging system 200 for the exemplary image-forming device 10. The charging system 200 includes a common power supply 40 that provides an AC voltage to the charging units 14A-D for each of the image-forming units 100A-D. That is, an AC voltage is applied to the charging units 14A-D using a shared high voltage power supply 40. In the illustrated embodiment, the power supply 40 also provides a shared DC charge. With this combination, power supply 40 provides common charging, including a DC component and an AC component, to each of the charging units 14A-D. The charging units 14A-D, in turn, charge the surface of the respective photoconductive units 12A-D. Each of the image-forming units represents one of the four colors cyan, magenta, yellow, and black. It will be apparent to those skilled in the art that the relative positions of the colors as well as the exact color hue of the toner may vary.

The charge provided by the power supply 40 passes through the charging units 14A-D, across a photoconductive layer 82 disposed about the exterior of the photoconductive units 12A-D and ultimately to a core 84 of the photoconductive units 12A-D. The core 84 of each photoconductive unit 12A-D is coupled to an electrical return, illustrated as grown in FIG. 3. It should be understood that the electrical return need not be ground and may in fact be some non-zero voltage level. The charging units 14A-D, the photoconductive layer 82, and the core 84 of the photoconductive 12A-D essentially form a load that is placed on the power supply 40. Further, the load is highly capacitive, largely due to the capacitive nature of the photoconductive layer 82 and the charging units 14A-D.

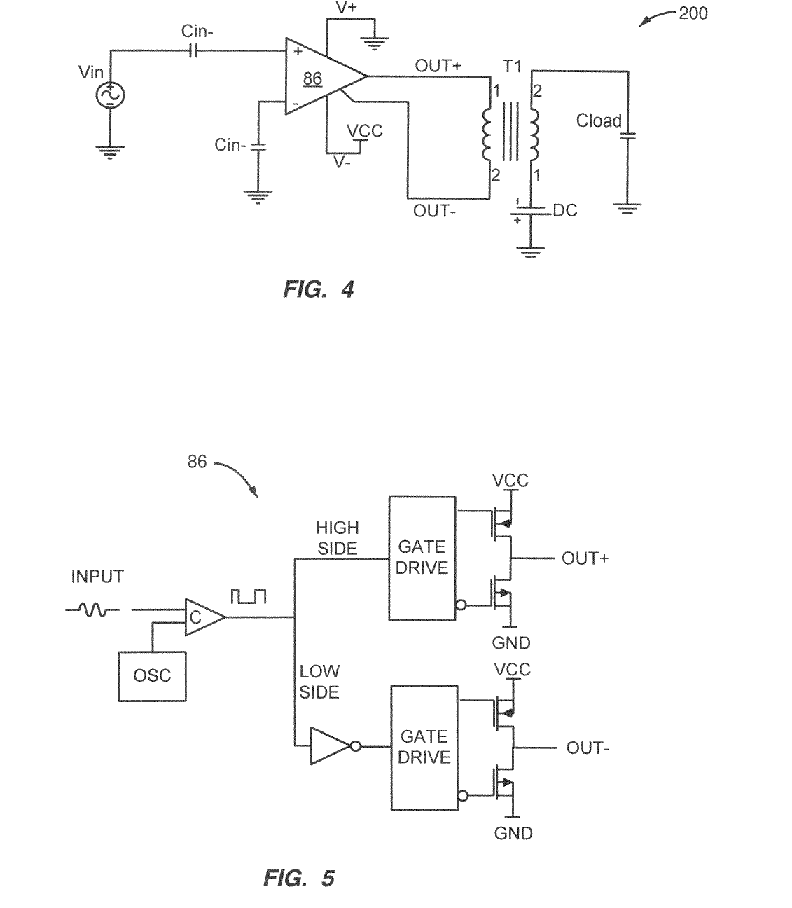

In a conventional system, the highly capacitive load discharges towards the power supply where the returned energy is dissipated in an output stage of a power amplifier. An AC power supply must then supply energy again to charge the capacitive load in an opposite polarity. This lost energy is wasted in thermal losses and limits the amount of capacitive load that the conventional power supply can drive. These drawbacks may be avoided by using a switching mode amplifier 86 as shown in FIG. 4 instead of a conventional linear power amplifier. In general, the switching mode amplifier 86 provides benefits over linear amplifiers by switching the output between ON (saturation) and OFF (cutoff) states as opposed to continually conducting in an active mode as do linear amplifiers. Thus, there is very little heat energy dissipated and energy efficiency is high.

In the present application, the AC input Vin may be provided by a sine wave generator and is amplified by the switching mode amplifier 86. The output of the amplifier 86 drives a transformer T1 that steps up the voltage to high charging levels. The secondary of the transformer T1 drives the photoconductor charging units 14A-D to charge the photoconductive units 12A-D. In FIG. 4, this photoconductor charging load is simply represented as a capacitive load Cload. Further, the AC charging component may be applied to the load Cload in coordination with a DC component as shown in FIG. 4 and as described herein.

Operation of a switching mode amplifier 86 is more completely depicted in FIG. 5. Generally, an analog input signal is converted into a pulse width modulated (PWM) signal that is ultimately used in driving a half-bridge output. In other embodiments, the amplifier 86 may include a full-bridge output. The PWM signal is generated by comparison (at comparator C) of the input signal against a predetermined carrier or reference wave signal produced by an oscillator (OSC). The reference signal may be a triangular wave, sawtooth wave, or other shape wave known in the art. The comparator C produces a square wave having a frequency that is determined by the frequency of the reference signal. This frequency may be fixed or variable as would be understood by one skilled in the art. The duty cycle of the square wave will depend upon the instantaneous value of the input signal relative to the instantaneous value of the reference signal. Since the reference signal is known, the square wave thus provides a digital representation of the input signal.

The square wave is bifurcated to drive two separate gate drives, which in turn drive half-bridge transistor outputs. A high side gate drive is driven by the unmodified square wave. A low side gate drive is driven by an inverted version of the square wave. Then, each gate drive switches the transistor (e.g., MOSFET transistors) outputs between the high VCC output and the low GND outputs to produce positive OUT+ and negative OUT− outputs. The outputs may be integrated by the load inductance, thereby filtering out much of the modulation frequency in the digitized output current. In one embodiment, the switching mode amplifier is a class D amplifier. An example of a suitable amplifier usable in the present embodiment is the Maxim MAX9713 amplifier available from Maxim Integrated Products in Sunnyvale, CA, USA.

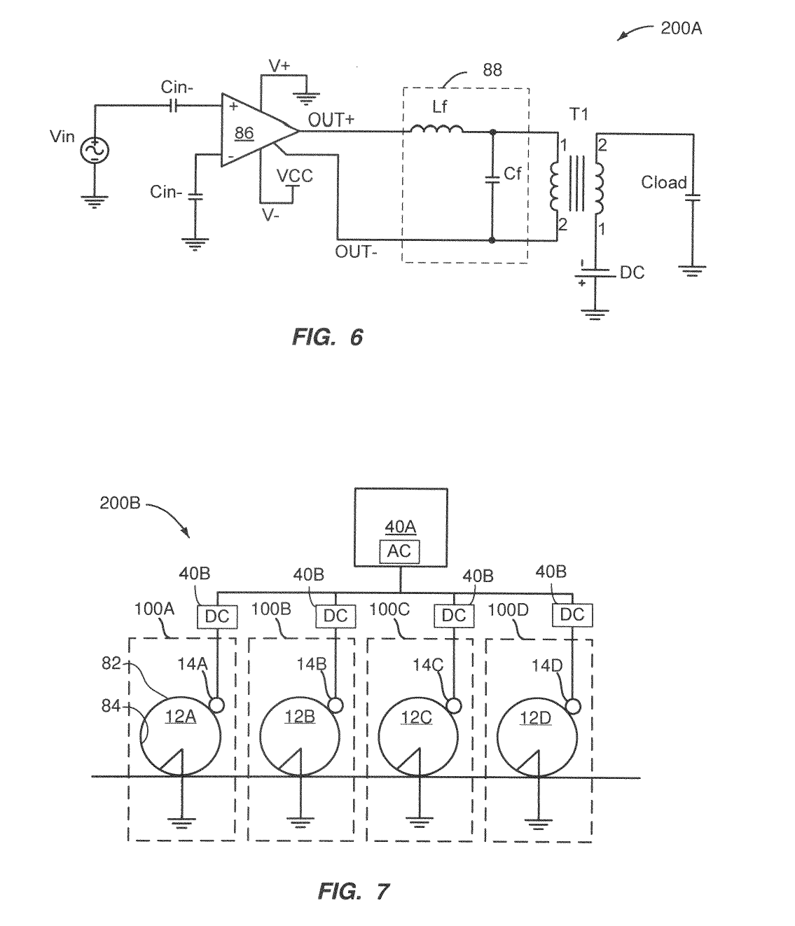

In certain instances, particularly with a capacitive load such as the photoconductor charging system, the load capacitance may be reflected through the transformer T1 to the primary side of the transformer T1. Thus, the amplifier load may appear at least partially capacitive. To alleviate these effects, the amplifier 86 output may be filtered as shown in the exemplary charging system 200A depicted in FIG. 6. Similar to FIG. 4, the AC charging component may be applied to the load Cload in coordination with a DC component as described herein. In the illustrated embodiment, filtering is implemented with filter 88. In one embodiment, the filter 88 is a first order L-C low pass filter. In other embodiments, higher order filters may be used. In other embodiments, other types of filters, including R-C filters, may be used. Certain commercially available class D amplifiers include internal filtering or are optimized to provide a filtered output given their intended application with loudspeakers having a predetermined impedance. Those skilled in the art will comprehend that an appropriate load/circuit analysis may be necessary to determine the appropriate filter, if any, necessary for a given application.

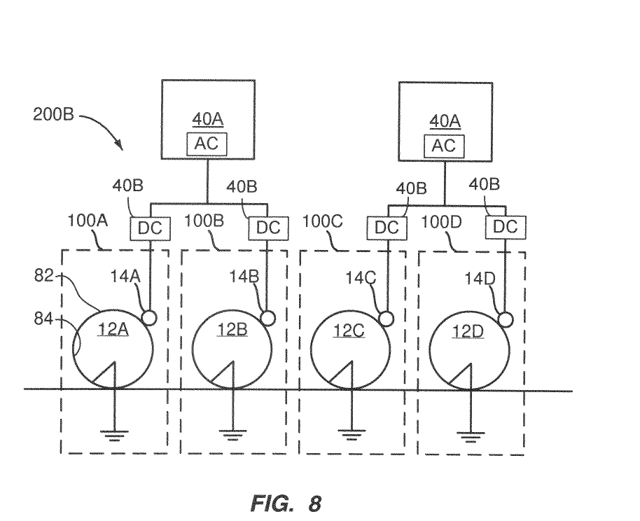

FIG. 3 depicts one embodiment of a charging system 200 in which the power supply 40 provides common charging, including common AC and DC components, to each of the charging units 14A-D. In one embodiment illustrated in FIG. 7, the charging system 200B may include a shared AC power supply 40A and one or more DC power supplies 40B. Specifically, a separate DC power supply 40B may be used to provide different DC charge levels at each charging unit 14A-D. In another unillustrated embodiment, a DC power supply 40B may be shared and provide a common DC charge level to two or more charging units 14A-D. The AC power supply 40B may be implemented as described above and may provide an AC charge component to each charging unit 14A-D. In another embodiment illustrated in FIG. 8, a separate AC power supply 40A may be shared to provide a common AC charge component to fewer than all of the charging units 14A-D in the embodiment shown, two AC power supplies 40A provide a common AC charge component to two of the four charging units 14A-D. In other embodiments, the AC power supplies 40A may provide an AC charge component to more or fewer charging units 14A-D.

The present invention may be carried out in other specific ways than those herein set forth without departing from the scope and essential characteristics of the invention. For example, the amplifier 86 described herein is implemented using discrete components. However, those skilled in the art will recognize that microcontroller-based amplifiers may be incorporated into programmable devices, including for example microprocessors, DSPs, ASICs, or other stored-program processors. The present embodiments are, therefore, to be considered in all respects as illustrative and not restrictive, and all changes coming within the meaning and equivalency range of the appended claims are intended to be embraced therein.

What is claimed is:

1. A photoconductor charging system for use with an image forming device, said charging system comprising:
a plurality of image forming units transferring toner particles to a media substrate, each of said plurality of image forming units comprising a photoconductive unit and a corresponding charging unit positioned to charge the photoconductive unit; and
a common alternating current power supply coupled to each of the charging units and supplying a voltage thereto.

2. The charging system of claim 1 wherein the image forming device comprises four image forming units.

3. The charging system of claim 1 wherein the alternating current power supply further comprises a switching mode amplifier.

4. The charging system of claim 3 further comprising a filter to filter an output of the switching mode amplifier.

5. The charging system of claim 4 wherein the filter is a low pass L-C filter.

6. The charging system of claim 1 wherein the alternating current power supply further comprises a class D amplifier.

7. The charging system of claim 1 further comprising a common direct current power supply coupled to each of the charging units and supplying a voltage thereto.

8. The charging system of claim 1 further comprising a separate direct current power supply coupled to each of the charging units and supplying a voltage thereto.

9. An electrophotographic image forming device comprising:
a first photoconductive unit;
a first charger unit to apply a charge to a surface of the first photoconductive unit; and
a switching mode amplifier coupled to the first charger unit and supplying an alternating current voltage thereto.

10. The image forming device of claim 9 further comprising:
a second photoconductive unit; and
a second charger unit to apply a charge to a surface of the second photoconductive unit,
the switching mode amplifier coupled to the second charger unit and supplying an alternating current voltage thereto.

11. The image forming device of claim 10 further comprising a single direct current power supply coupled to each of the first and second charger units and supplying a voltage thereto.

12. The image forming device of claim 10 further comprising a first and a second direct current power supply coupled respectively to the first and second charger units and supplying a voltage thereto.

13. The image forming device of claim 9 further comprising a filter to filter an output of the switching mode amplifier.

14. The image forming device of claim 13 wherein the filter is a low pass L-C filter.

15. The image forming device of claim 9 wherein the switching mode amplifier comprises a class D amplifier.

16. The image forming device of claim 9 wherein the switching mode amplifier comprises a half-bridge transistor output stage.

17. An electrophotographic image forming device comprising:
a first photoconductive unit;
a first charger unit to apply a charge to a surface of the first photoconductive unit;
a second photoconductive unit;
a second charger unit to apply a charge to a surface of the second photoconductive unit, and
a class D amplifier coupled to the first charger unit and to the second charger unit and supplying an alternating current voltage thereto to charge the respective photoconductor units.

18. The image forming device of claim 17 further comprising a filter to filter an output of the class D amplifier.

19. The image forming device of claim 18 wherein the filter is a low pass L-C filter.

20. The image forming device of claim 17 wherein the switching mode amplifier comprises a half-bridge transistor output stage.

21. The image forming device of claim 17 further comprising a single direct current power supply coupled to each of the first and second charger units and supplying a voltage thereto.

22. The image forming device of claim 17 further comprising a first and a second direct current power supply coupled respectively to the first and second charger units and supplying a voltage thereto.

23. A method of charging a photoconductive surface in an image forming device comprising the steps of:
comparing an oscillating input signal to a predetermined reference signal to produce a pulse-width-modulated signal representative of the input signal;
driving a transistor output bridge using the pulse-width modulated signal so that the transistors switch between ON and OFF states to respectively produce a substantially binary output voltage;
filtering the binary output voltage to produce a filtered alternating current signal;
transforming the filtered alternating current signal to a high voltage alternating current signal; and
applying the high voltage alternating current signal to a photoconductor charging unit to charge a photoconductive surface of a photoconductor.

24. The method of claim 23 wherein the reference signal is a triangle wave.

25. The method of claim 23 wherein the reference signal is a sawtooth wave.

26. The method of claim 23 wherein the transistor output bridge is a half-bridge circuit.

27. The method of claim 23 wherein the step of applying the high voltage alternating current signal to a photoconductor charging unit to charge a photoconductive surface of a photoconductor further comprises applying the high voltage alternating current signal to a plurality of photoconductor charging units to respectively charge a photoconductive surface of a plurality of photoconductors.

28. The method of claim 27 further comprising adding a common direct current component to the high voltage alternating current signal that is applied to the plurality of photoconductor charging units to respectively charge the photoconductive surface of the plurality of photoconductors.

29. The method of claim 27 further comprising adding a distinct direct current component to the high voltage alternating current signal that is applied to each of the plurality of photoconductor charging units to respectively charge the photoconductive surface of the plurality of photoconductors.

30. The method of claim 23 further comprising driving a low side transistor output bridge using an inverse of the pulse-width modulated signal so that the low side transistors switch between ON and OFF states to respectively produce a second substantially binary output voltage.
